(19) United States
(12) Patent Application Publication
(10) Pub. No.: US 2024/0185556 A1
(43) Pub. Date: Jun. 6, 2024

(54) GEOSPATIAL IMAGE LABELING AND FEATURE CHANGE DETECTION

(71) Applicant: CACI, INC.- FEDERAL, Reston, VA (US)

(72) Inventor: Brandon KRUELLE, Reston, VA (US)

(21) Appl. No.: 18/072,779

(22) Filed: Dec. 1, 2022

(51) Int. Cl. G06V 10/44; G06V 20/10; G06V 20/60

(52) U.S. Cl. CPC G06V 10/443; G06V 20/10; G06V 20/60

(57) ABSTRACT

The application describes systems, methods, and computer program products for analyzing geospatial images and applying change detection techniques. Feature extraction modules may utilize machine learning techniques to process geospatial images and determine a set of target features. The target features may be compared against previous feature label sets and utilize a feature specification and variability parameter to determine whether to update label sets with one or more target features. Embodiments further provide visual mapping techniques and accuracy refinements.

### TECHNICAL FIELD

This application is generally related to methods and apparatuses for analyzing geospatial images and applying machine learning techniques to detect changes and update feature labels.

### BACKGROUND

Geospatial images, such as satellite images, may contain visual information about features, like roads, buildings, and other structures within a geospatial area. Maps of the geospatial area may reflect those features and provide information about those features through one or more labels. Over time, features may change, and new features may arise within the geospatial area, such as when a new road or building is constructed.

When updated images are obtained, they are typically manually reviewed and compared to previous images and/or labeled maps of previously identified features. Any changes are manually, identified, labeled, and updated. Some features can be very difficult to detect and identify, especially in low resolution images, and satellite images, where buildings and similar structures may appear very small. Image analyses and feature updates may therefore be very time consuming and often require trained human analysts. Accordingly, there is a need to accurately and efficiently analyze geospatial images and update information that may be represented in those images.

### SUMMARY

The foregoing needs are met, to a great extent, by the disclosed apparatus, system and method for analyzing, labeling, and updating geospatial images. In some embodiments, a geospatial image may be a satellite image of a geospatial area, or other indoor or outdoor area of interest. Embodiments may provide systems and methods for analyzing the geospatial image, identifying features, and detecting changes between a previous feature label set associated with the geospatial area and/or a prior geospatial image.

In various embodiments, computer-implemented systems, methods, and computer program products may receive information indicative of a geospatial image, apply a trained feature extraction module to detect a first target feature based on a feature specification, map the first target feature against a set of labeled features within an area defined by the geospatial image, determine that the first target feature is new, based on a threshold distance value between the first target feature and a first labeled feature, and update the set of labeled features with the first target feature.

Moreover, some embodiments may receive information indicative of a geospatial image; apply a trained feature extraction module to detect a set of detected features, associate an object type with a first feature in the set of detected features, map the set of detected features against a set of known features in a labeled image, determine a distance between the first feature and a nearest feature in the labeled image, generate a threshold distance value based on the object type and an aggressiveness parameter, add the first feature to the labeled image when the distance is greater than or equal to the threshold distance value, and replace the nearest feature with the first feature when the distance is less than the threshold distance value.

One or more implementations may include a computer-readable storage medium, and instructions stored on the computer-readable storage medium that, when executed by a processor, causes the processor to: receive information indicative of a geospatial image, apply a trained feature extraction module to detect a first target feature, cause a display to map the first target feature against a set of labeled features within an area defined by the geospatial image, determine that the first target feature is new, based on a threshold distance value between the first target feature and a first labeled feature, wherein the threshold distance value is based on a feature specification and a variability allowance for the feature specification, and update the set of labeled features with the first target feature. The processor may further be configured to label the first target feature as an existing feature when a distance between the first target feature and the first labeled feature is below the threshold distance value and label the first target feature as a new feature when the distance between the first target feature and the first labeled feature is greater than or equal to the threshold distance value.

In some embodiments, the feature specification defines an object type based on at least one of an object shape, an object area, or an object size. An object type may be a building type, a structure, or a landmark. The threshold distance value may be based on the feature specification and an aggressiveness parameter, wherein the aggressiveness parameter defines a variability allowance for the feature specification. The threshold distance value may also be based on a center point distance between the first feature and the first labeled feature.

In examples, the trained feature extraction module performs object recognition trained on at least one set of labeled features. In examples, detected features may be based on a feature specification associating the object type with one or more of a shape, an area, or a location. Embodiments may also detect, by the trained feature extraction module, a second target feature, and merge the first and second target features based on a distance parameter and the feature specification. The trained model may also perform object recognition, and be trained based on detected features, updated images, label sets, sets of geospatial images, and the like.

Embodiments may provide a visual mapping of the first target feature relative to the set of labeled features. The mapping may comprise a labeled image displaying a nearest feature in a first color a first feature, e.g., a detected feature, in a second color.

Various aspects and implementations may receive and incorporate manual updates, for example, to update the set of labeled features, refine a location, or change a specification associated with a particular feature or object type.

The above summary may present a simplified overview of some embodiments of the invention in order to provide a basic understanding of certain aspects of the invention discussed herein. The summary is not intended to provide an extensive overview of the invention, nor is it intended to identify any key or critical elements or delineate the scope of the invention. The sole purpose of the summary is merely to present some concepts in a simplified form as an introduction to the detailed description presented below.

### BRIEF DESCRIPTION OF THE DRAWINGS

The accompanying drawings, which are incorporated in and constitute a part of this specification, illustrate various embodiments of the invention and, together with the general description of the invention given above, and the detailed description of the embodiments given below, serve to explain the embodiments of the invention. These drawings should not be construed as limiting the invention and are intended only to be illustrative.

FIG. 1A illustrates a node according to an aspect of the application.

FIG. 1B illustrates a computing system used to implement one or more nodes according to an aspect of the application.

FIG. 2 illustrates a ML model for feature extraction, according to an aspect of the application.

FIG. 3 illustrates an example output of an image change detection operation, according to an aspect of the application.

FIG. 4 illustrates an image change detection process, according to an aspect of the application.

FIG. 5 illustrates a flowchart for updating label sets, according to an aspect of the application.

FIG. 6 illustrates a flowchart for updating a labeled image, according to an aspect of the application.

### DETAILED DESCRIPTION

A detailed description of the illustrative embodiment will be discussed in reference to various figures, embodiments, and aspects herein. Although this description provides detailed examples of possible implementations, it should be understood that the details are intended to be examples and thus do not limit the scope of the application.

Reference in this specification to “one embodiment,” “an embodiment,” “one or more embodiments,” “an aspect” or the like means that a particular feature, structure, or characteristic described in connection with the embodiment is included in at least one embodiment of the disclosure. Moreover, the term “embodiment” in various places in the specification is not necessarily referring to the same embodiment. That is, various features are described which may be exhibited by some embodiments and not by the other.

In this respect, before explaining at least one embodiment of the invention in detail, it is to be understood that the invention is not limited in its application to the details of construction and to the arrangements of the components set forth in the following description or illustrated in the drawings. The invention is capable of embodiments or embodiments in addition to those described and of being practiced and carried out in various ways. Also, it is to be understood that the phraseology and terminology employed herein, as well as the abstract, are for the purpose of description and should not be regarded as limiting.

Reference in this application to “one embodiment,” “an embodiment,” “one or more embodiments,” or the like means that a particular feature, structure, or characteristic described in connection with the embodiment is included in at least one embodiment of the disclosure. The appearances of, for example, the phrases “an embodiment” in various places in the specification are not necessarily all referring to the same embodiment, nor are separate or alternative embodiments mutually exclusive of other embodiments. Moreover, various features are described which may be exhibited by some embodiments and not by the other. Similarly, various requirements are described which may be requirements for some embodiments but not by other embodiments.

As used throughout this application, the word “may” is used in a permissive sense (i.e., meaning having the potential to), rather than the mandatory sense (i.e., meaning must). The words “include,” “including,” and “includes” and the like mean including, but not limited to. As used herein, the singular form of “a,” “an,” and “the” include plural references unless the context clearly dictates otherwise. As employed herein, the term “number” shall mean one or an integer greater than one (i.e., a plurality).

As used herein, the statement that two or more parts or components are “coupled” shall mean that the parts are joined or operate together either directly or indirectly, i.e., through one or more intermediate parts or components, so long as a link occurs. As used herein, “directly coupled” means that two elements are directly in contact with each other.

Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device.

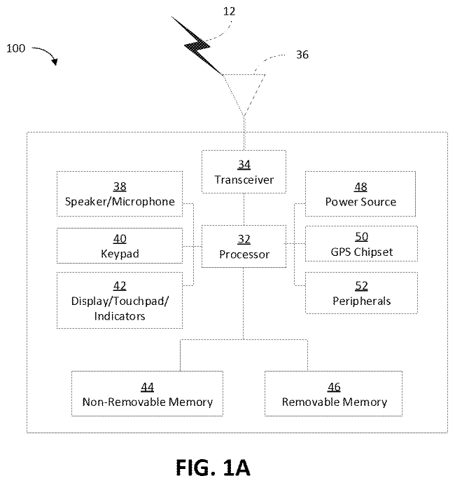

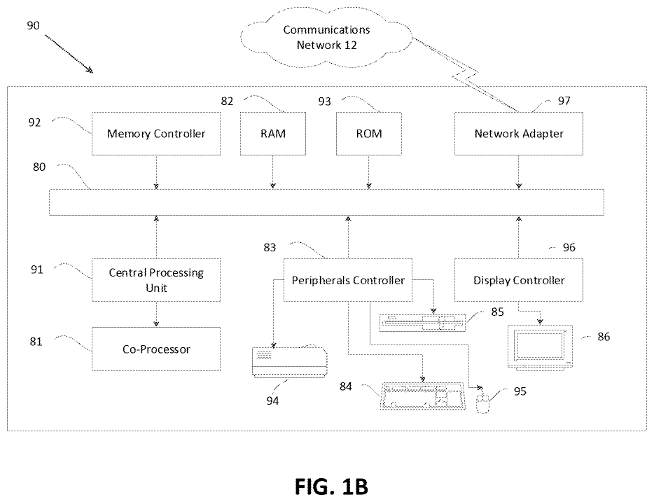

FIG. 1A shows an example hardware/software architecture of a node of a network, server, gateway, device, or other node. As shown in FIG. 1A, the node 30 may include a processor 32, non-removable memory 44, removable memory 46, a speaker/microphone 38, a keypad 40, a display, touchpad, and/or indicators 42, a power source 48, a global positioning system (GPS) chipset 50, and other peripherals 52. The node 30 may also include communication circuitry, such as a transceiver 34 and a transmit/receive element 36. It will be appreciated that the node 30 may include any sub-combination of the foregoing elements while remaining consistent with an embodiment.

The processor 32 may be a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., memory 44 and/or memory 46) of the node in order to perform the various required functions of the node. For example, the processor 32 may perform signal coding, data processing, power control, input/output processing, and/or any other functionality that enables the node 30 to operate in a wireless or wired environment. The computer executable instructions stored in the memory of the node and executed by the processor. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

As shown in FIG. 1A, the processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected. While FIG. 1A depicts the processor 32 and the transceiver 34 as separate components, it will be appreciated that the processor 32 and the transceiver 34 may be integrated together in an electronic package or chip.

The transmit/receive element 36 may be configured to transmit signals to, or receive signals from, other nodes, including M2M servers, gateways, device, and the like. For example, in an embodiment, the transmit/receive element 36 may be an antenna configured to transmit and/or receive RF signals. The transmit/receive element 36 may support various networks and air interfaces, such as WLAN, WPAN, cellular, and the like. In an embodiment, the transmit/receive element 36 may be an emitter/detector configured to transmit and/or receive IR, UV, or visible light signals, for example. In yet another embodiment, the transmit/receive element 36 may be configured to transmit and receive both RF and light signals. It will be appreciated that the transmit/receive element 36 may be configured to transmit and/or receive any combination of wireless or wired signals.

In addition, although the transmit/receive element 36 is depicted in FIG. 1A as a single element, the node 30 may include any number of transmit/receive elements 36. More specifically, the node 30 may employ MIMO technology. Thus, in an embodiment, the node 30 may include two or more transmit/receive elements 36 (e.g., multiple antennas) for transmitting and receiving wireless signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple RATs, such as UTRA and IEEE 802.11, for example.

The processor 32 may access information from, and store data in, any type of suitable memory, such as the non-removable memory 44 and/or the removable memory 46. For example, the processor 32 may store session context in its memory, as described above. The non-removable memory 44 may include random-access memory (RAM), read-only memory (ROM), a hard disk, or any other type of memory storage device. The removable memory 46 may include a subscriber identity module (SIM) card, a memory stick, a secure digital (SD) memory card, and the like. In other embodiments, the processor 32 may access information from, and store data in, memory that is not physically located on the node 30, such as on a server or a home computer. The processor 32 may be configured to control lighting patterns, images, or colors on the display or indicators 42 to reflect the status of communications and to provide a graphical user interface.

The processor 32 may receive power from the power source 48 and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 32 may also be coupled to the GPS chipset 50, which is configured to provide location information (e.g., longitude and latitude) regarding the current location of the node 30. It will be appreciated that the node 30 may acquire location information by way of any suitable location-determination method while remaining consistent with an embodiment.

The processor 32 may further be coupled to other peripherals 52, which may include one or more software and/or hardware modules that provide additional features, functionality and/or wired or wireless connectivity. For example, the peripherals 52 may include various sensors such as an accelerometer, biometrics (e.g., fingerprint) sensors, an e-compass, a satellite transceiver, a digital camera (for photographs or video), a universal serial bus (USB) port or other interconnect interfaces, a vibration device, a television transceiver, a hands free headset, a Bluetooth® module, a frequency modulated (FM) radio unit, a digital music player, a media player, a video game player module, an Internet browser, and the like.

The node 30 may be embodied in other apparatuses or devices, such as a sensor, consumer electronics, a wearable device such as a smart watch or smart clothing, a medical or eHealth device, a robot, industrial equipment, a drone, a vehicle such as a car, truck, train, or airplane. The node 30 may connect to other components, modules, or systems of such apparatuses or devices via one or more interconnect interfaces, such as an interconnect interface that may comprise one of the peripherals 52.

FIG. 1B is a block diagram of an exemplary computing system 90 which may also be used to implement one or more nodes of a network (e.g., the nodes of the network 100 in FIG. 1). Computing system 90 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 90 to do work. In many known workstations, servers, and personal computers, central processing unit 91 is implemented by a single-chip CPU called a microprocessor. In other machines, the central processing unit 91 may comprise multiple processors. Coprocessor 81 is an optional processor, distinct from main CPU 91 that performs additional functions or assists CPU 91.

In operation, CPU 91 fetches, decodes, and executes instructions, and transfers information to and from other resources via the computer's main data-transfer path, system bus 80. Such a system bus connects the components in computing system 90 and defines the medium for data exchange. System bus 80 typically includes data lines for sending data, address lines for sending addresses, and control lines for sending interrupts and for operating the system bus. An example of such a system bus 80 is the PCI (Peripheral Component Interconnect) bus.

Memories coupled to system bus 80 include random access memory (RAM) 82 and read only memory (ROM) 93. Such memories include circuitry that allows information to be stored and retrieved. ROMs 93 generally contain stored data that cannot easily be modified. Data stored in RAM 82 can be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode can access only memory mapped by its own process virtual address space; it cannot access memory within another process's virtual address space unless memory sharing between the processes has been set up.

In addition, computing system 90 may contain peripherals controller 83 responsible for communicating instructions from CPU 91 to peripherals, such as printer 94, keyboard 84, mouse 95, and disk drive 85.

Display 86, which is controlled by display controller 96, is used to display visual output generated by computing system 90. Such visual output may include text, graphics, animated graphics, and video. Display 86 may be implemented with a CRT-based video display, an LCD-based flat-panel display, gas plasma-based flat-panel display, or a touch-panel. Display controller 96 includes electronic components required to generate a video signal that is sent to display 86. The display may include a graphical user interface such as those illustrated in the accompanying figures and described below in more detail.

Further, computing system 90 may contain communication circuitry, such as for example a network adaptor 97, that may be used to connect computing system 90 to an external communications network to enable the computing system 90 to communicate with other nodes of the network.

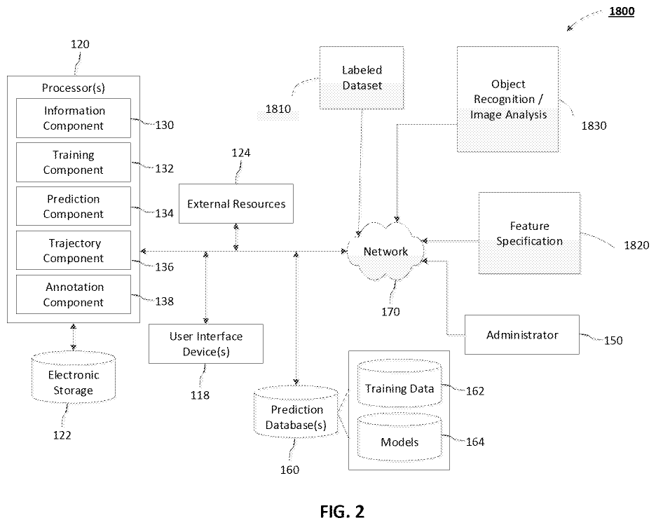

FIG. 2 illustrates an example machine learning (ML) architecture usable with the geospatial image analyses, feature extraction, and change detection processes discussed herein.

In an embodiment, one or more trained ML models may be located at a network, such as a satellite network(s), or at a remote cloud server(s). The ML model(s) 164 may already be trained, e.g., based on previously labeled sets, identified features, feature specifications, and the like. In another embodiment, the ML model(s) 164 may need to be trained prior to performing a determination (or retrained in view of new training data). Here, training component 132 may implement an algorithm for building and training one or more deep neural networks of the model 164. The model 164 may be trained using training data 162. For example, the training data 162 may be obtained from prediction database 160 and comprise hundreds, thousands, or even many millions of pieces of information.

According to an embodiment, the prediction database(s) 160 may obtain an entirely labeled dataset 1810 (or labeled subset 1820). The labeled dataset 1810 may be used as training data 162 to train a model 164. Once the model 164 is trained and confident to examine unlabeled data 1830, the model 160 is ready to be deployed to determine an imminent event(s). The labeled dataset 1810 may be received from a data seller/licensor, data labeler and/or an administrator 150 on the current or another network.

A previously labeled dataset 1810, feature specification 1820, and object recognition/image analysis 1830 data may all be received from one or more external sources. For example, a labeled dataset 1810 may be uploaded into the system, feature specifications 1820 may be received from one or more vendors, which may each have their own sets or formats, and object recognition/image analysis data 1830 may provide information regarding target feature characteristics.

According to an embodiment, labeling of unlabeled subsets of an obtained larger dataset may be performed by one or more ML model(s) 164 in view of the obtained feature specifications 1820. The feature specifications 1820 may be obtained, for example, from data seller/licensor, data labeler and/or an administrator 150 on the current or another network. More specifically, the prediction database(s) 160 may employ the labeled subset 1820 to train one or more of the ML model(s) 164 in order to develop robust training data 162. Training of the ML model 164 may last until the ML model 164 has a certain level of confidence based on what it has learned so far in view of a labeled subset 1820. The ML model 164 then evaluates and automatically applies labels to the unlabeled subset(s). If the ML model 164 feels that a specific datum of the unlabeled subset does not meet a certain confidence threshold, the ML model 164 transmits the specific datum to a repository or another node. The datum may be labeled by another model, or manually by a user, in view of the labelled subset 1820. Once the datum has been labelled, it may be transmitted back to the ML model 164. The ML model 164 may learn from the labeled data and improves its ability to automatically label the remaining unlabeled subset of data. Training data 162 may be generated in view of the labeled dataset. As further shown in FIG. 2, the training data 162 may be transmitted to one or more other models 164.

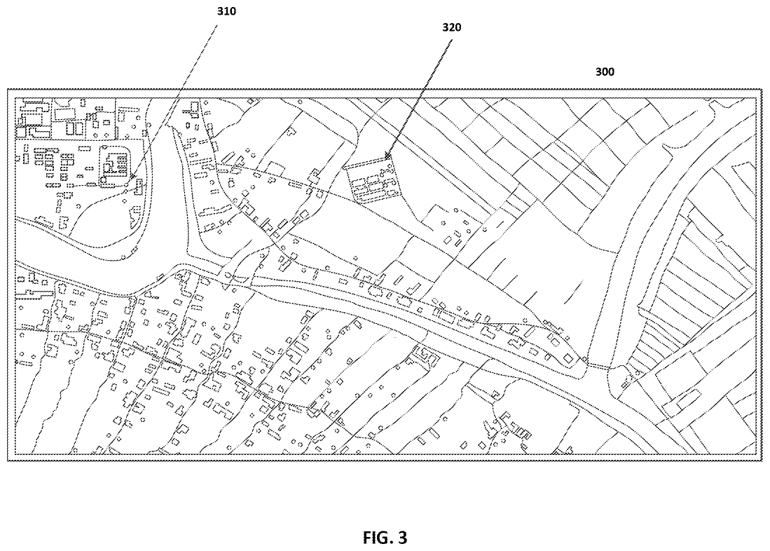

FIG. 3 illustrates an example output of an image change detection operation, in accordance with embodiments discussed herein. Geospatial image 300 provides a visualization of a geospatial area. The geospatial image may be an aerial image, such as a satellite image. As discussed in further detail below, aspects of the present invention may provide a visualization identify a set comprising at least one target feature, different from a set of previously labeled features associated with the geospatial area.

In the geospatial image, a previously labeled feature 310 may be displayed differently than a target feature 320. A previously labeled feature 310 may be visualized, for example, with a first color, shading, or marking, and the target feature 320 may be visualized, for example, with a second color, shading, or marking.

The target feature 320 may be a newly found feature, not previously found in prior images and/or sets of previously labeled features. For example, as illustrated in FIG. 3, the target feature 320 is a building complex. The building complex may have been newly built, and therefore not identified in previously analyzed images and label sets generated prior to the building complex's creation.

In another example, the target feature 320 may be a feature which was present on the prior image and label set, but not found on the newly analyzed geospatial image. For example, if a building complex or other structure was demolished or otherwise removed, it may not be present on new images of the geospatial area. In that instance, the target feature may identify a discrepancy between the previously taken image and the new image.

In yet another example, the target feature 320 may overlap with one or more features which were present on the previously labeled image. This may be the result of a mismatched or misaligned comparison between the previously labeled image and the new image. In such instances, as further discussed below, one or more analyses may be applied to determine whether the target feature should be considered a same or a different feature than a previously identified feature.

The overlapping features may also be the result of new construction, completion, and/or expansion of a previously identified feature. For example, if the previous image identified a partially completed building, and the new image identified a larger building structure in a same or substantially similar location, the larger building structure would not necessarily be a new feature. The larger building structure (i.e., the target feature in this example), would be identified on the geospatial image as a change from the previously labeled image and feature set.

As discussed herein, the target features may be automatically added to a labeled image, map, or the like. In some embodiments, target features may require manual review to confirm or deny the target feature's addition to the labeled feature set. A manual review may allow for adjustments in positioning, size, object type, and other aspects of the target feature's label.

In various examples, the geospatial image and at least one of its labeled features or the target features may be displayed on a display, screen, monitor, or the like, on a computing device. The geospatial image may enable a viewing selection of any or all of previously labeled features, target features, and area within the geospatial image. Similarly, colors, shading, and display of the image and any features may be adjusted.

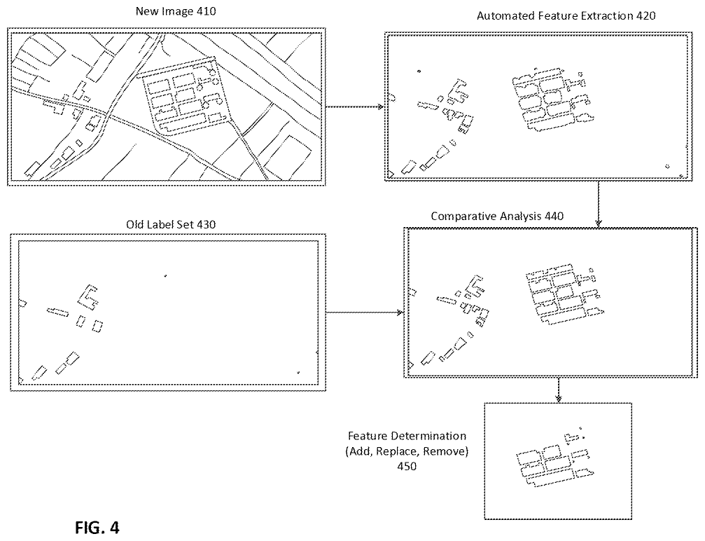

FIG. 4 provides a visualization of an image change detection process, in accordance with embodiments. A computing system may receive a new image 410 indicative of a geospatial area. The new image undergoes automated feature extraction 420, which may be implemented using a trained machine learning module. The trained machine learning module identifies any features present in the image. The machine learning module may be trained, for example, on previously labeled images with labeled objects. The previously labeled images may be manually labeled and/or labeled using one or more computing processes. For example, an object recognition module may assist in training the machine learning module and recognizing one or more objects. As discussed herein, identified features may be indicative an object type. Object types may include, for example, a building, a structure, a road, a land feature, such as a waterway or mountain, and the like.

In examples, the trained feature extraction module may perform object recognition trained on at least one set of labeled features. Accordingly, results from the image change detection processes discussed herein may also be used to train the model, e.g., in a feedback loop.

In various implementations, the feature extraction module may also be trained on a feature specification. A feature specification may be a set of characteristics associated with an object type. For example, a feature specification for a building may include a size, a size range, a shape, a density of features, and/or any other observable characteristic identifiable in the image. A feature specification for a grouping of buildings, e.g., a building complex, may include a minimum number of rectangular shapes clustered together within a region of a particular size. Various embodiments may utilize image scale information to estimate a size of an identified shape, object, or other observable feature may align with a feature specification and be an object of interest.

Automated feature extraction 420 may identify a set of target features. The set of target features include at least one target feature, which may conform to a feature specification. Target features may also be associated with an object type.

Optionally, output from the automated feature extraction may be converted into a format of choice, such as a GeoTIFF file, or shapefile. Any of a plurality of imaging files and formats may be used, especially those usable or otherwise associated with geospatial imaging, attribute information, aerial imaging, and the like.

The automated feature extraction output may be cleaned and divided, based on at least one of an object type or a size. For example, the images of FIG. 4 illustrate a building complex comprising a plurality of buildings within an area. The target feature may be either the entire building complex, or any of the plurality of buildings that make up the building complex. The feature extraction output may be split into additional categories, such as large and small buildings, based on a feature specification. The feature specification may, for example, indicate that buildings of a first size or footprint, e.g., 10,000 square feet or more, be labeled a large building, whereas buildings of a second, smaller size, may be labeled a small building.

A feature's center point may also be utilized in the labeling process. In the above example, center points between the buildings, e.g., between small and large buildings may be used to identify whether the combination of buildings form a building complex, neighborhood, or other label designation defined in the specification.

Center point measurements may also be utilized in the comparative analysis operations 440. The automated feature extraction output, including the identified object types, may undergo comparative analysis 440 against a previously labeled image or previous label set (also referred to herein as a set of labeled features). In examples, the previously labeled image may display the previous label set. The previous label set may comprise information indicative of one or more objects, and associated location information.

The comparative analysis compares the previous label set to the feature extraction output to identify any changes between the prior information for the geospatial area, and the current information, provided in the new image 410. The previous label set may be manually or automatically input for analysis. In other examples, the previous label set may be extracted from a previously taken image, and undergo similar automated feature extraction operations, as discussed herein.

The comparative analysis operations may identify distances between features in the previous label set and one or more nearby features in the new label set. The distance between objects may be based on an object's center point determination. Distances may be determined, for example, between each feature in the previously labeled set, and each feature in the labeled set from the new image.

The measurements between the old and new features may be compared against a threshold value, to determine how to update the label set. If a previously labeled feature is a greater distance away from any new feature than the threshold value, the previously labeled feature may be considered a destroyed building. This could indicate that the previously labeled feature should be removed from the updated feature label set.

In another scenario, if a new feature is a greater distance away from any previously labeled feature than the threshold value, the new feature may be considered a constructed building. This could indicate that the new feature should be added to the updated feature label set.

The threshold value may generate based on one or both of a feature specification and an aggressiveness parameter. The feature specification may indicate a distance or distance range between objects, to indicate a particular characteristic. For example, two buildings may require a minimum distance between them in order to indicate that they are separate objects. In another example, two extracted features that partially overlap would indicate that they may be part of the same feature (e.g., a same building, an addition or extension built onto the building, etc.). The two overlapping features would therefore not meet the minimum distance requirement in the feature specification to be considered two separate buildings.

The aggressiveness parameter may define a variability allowance for the feature specification. For example, in an image depicting a city area, the minimum distance between buildings may be smaller than images depicting a rural area. The aggressiveness parameter may therefore be changed to adjust for the differences.

The aggressiveness parameter may be a multiplier on top of a distance specification. For example, if a distance parameter between buildings required 10 meters of space to identify separate features, the aggressiveness parameter may be a multiplier, e.g., 1.5×, to increase the distance parameter to 15 meters. In a similar manner, the aggressiveness parameter may be decreased to 0.5×, or 5 meters.

The aggressiveness parameter may be manually adjusted, for example, along a sliding scale. A greater aggressiveness parameter may require stricter conformance to a feature specification and reduce flexibility with respect to variability that may occur in the comparative analysis operations. A reduced aggressiveness parameter may allow for greater variability in conformance to feature specifications.

Accordingly, a greater aggressiveness parameter may result in smaller false positives and greater false negatives with respect to labeling. A reduced aggressiveness parameter may result in the opposite, with greater false positives a lower false negatives with respect to labeling.

Referring to the example above, the grouping of buildings may be labeled differently depending on the aggressiveness parameter, and its resulting impact on the threshold value. A high aggressiveness parameter may return a smaller threshold value and may therefore label more identified objects as “new objects” than it should. A lower aggressiveness parameter may result in the opposite, wherein less identified objects are considered new, since the threshold distance value may be significantly greater, and therefore less objects meet the required threshold value to be considered new.

After the comparative analysis operations, feature determination 450 occurs. The feature determinations utilize the threshold distance values, as discussed above, to determine whether to add, replace, or remove one or more objects in the label set. Newly identified objects may be added to the label set. Destroyed objects may be removed from the data set. Identified changes, e.g., an expansion of a building or other object, may cause an object from the previous label set to be replaced.

In any or all of the above operations, manual input can adjust one or more aspects of each operation. For example, an object type may be changed if its designation is deemed incorrect. Labels on both the previous set and the updated set may be adjusted. The threshold distance and aggressiveness parameters may also be adjusted. Each aspect of the image change detection process may be customized.

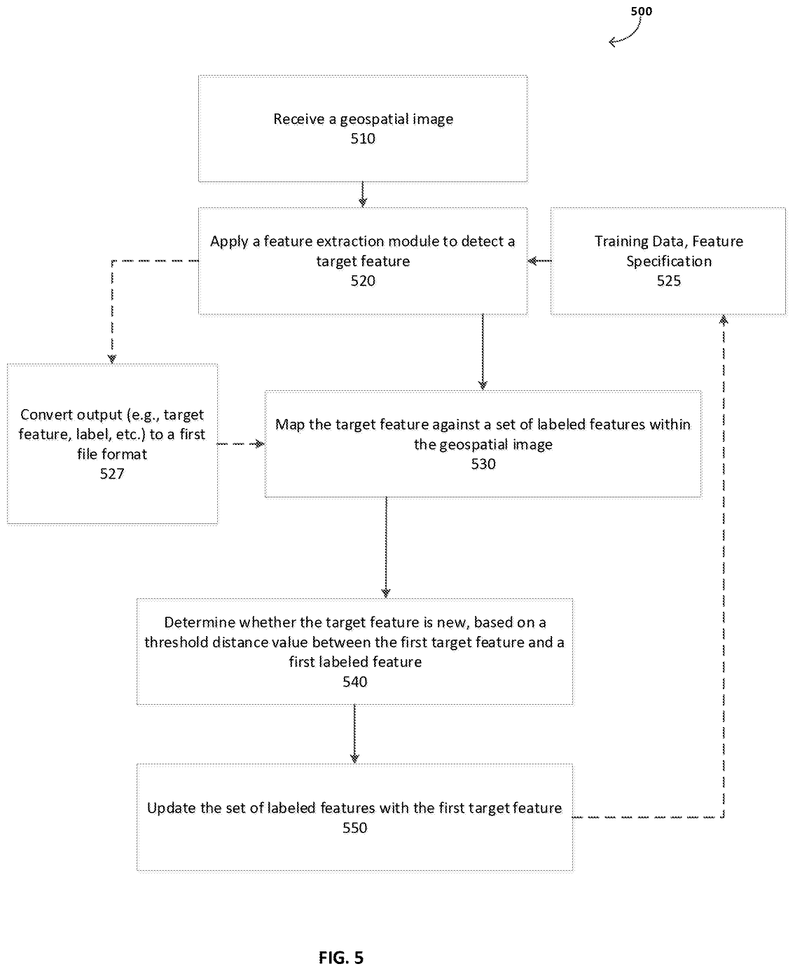

FIG. 5 illustrates a flowchart of an image change detection and labeling process 500, in accordance with embodiments. At block 510, systems and methods may receive a geospatial image 510. As discussed herein, the geospatial image may be a satellite image, an aerial image, and the like. Embodiments may receive information about a geospatial image, in a variety of file types and formats, depending on the particular implementation.

In some embodiments, receiving the geospatial image may further comprise generating a pixel map of the geospatial image, converting objects to vectors, polygons, and the like, and using such shapes in feature extraction modules discussed herein.

At block 520, a feature extraction module may be applied to detect a target feature 520. The target feature may be an object of interest in the image, such as a building, a structure, a land feature, a roadway, and the like. The target feature may be defined by a feature specification, which may define an object or object type based, for example, on an object shape, and object area, or an object size.

The feature extraction module may be a trained machine learning model, such as the trained feature extraction module discussed herein. In embodiments, the feature extraction module may utilize object recognition techniques, as known to those skilled in the art. As indicated in block 525, the feature extraction module may use any of a combination of training data, such as previously labeled geospatial images, feature specification information, object type information, a set of labeled features, and manual input to identify one or more target features. The one or more target features may be referred to herein as a set of target features.

In an example, the feature extraction module may identify a first target feature and the second target feature. The two target features may be merged based on a distance parameter and a feature specification. For example, if two target features are potentially indicative of buildings (e.g., based on a building feature specification), and do not meet a distance parameter, which may be defined in the building specification, then the two target features may be merged into a single target feature. As such, the two target features may represent a single object, such as a single building.

At bock 527, the set of target features may optionally be converted into a first file format. For example, the set of target features, and/or a set of labels associated with the set of target features may be converted to a GeoTIFF or shapefile. Any or all of the geospatial image, the set of target features, associated labels (e.g., object type, etc.), and any other output from the feature extraction module may be cleaned and converted to a desired format.

At block 530, the target feature may be mapped against a set of labeled features within the geospatial image. The target feature may be mapped, for example, against a set of labeled features within an area defined by the geospatial image. The area may be a portion of the geospatial image, or area covered by the set of labeled features, for example. The set of labeled features may be a set of previously labeled features corresponding to at least a portion of the area defined in the geospatial image. The mapping may further comprise a visual mapping of the set of target features relative to the set of labeled features. As discussed with respect to FIG. 3, a target feature may be mapped in a first color, shading or marking, and the set of labeled features may be mapped in a second color, shading or marking. In such examples, the set of target features and the set of labeled features may be distinguishable.

At block 540, systems and methods may determine whether the target feature is new, based on a threshold distance value between the first target feature and a first labeled feature. The threshold distance value may be based on a center point distance between the first target feature and the first labeled feature. In examples, the target feature may be measured relative to the set of labeled features. If the target feature meets or exceeds the threshold distance value, it may be labeled as a new feature as discussed herein. If the target features are less than the threshold distance value, it may be merged with the labeled feature and/or replace the labeled feature.

In additional examples, the threshold distance value may be based on a feature specification and a variability allowance (e.g., an aggressiveness parameter). As discussed herein, the variability allowance may be manually adjusted and thereby allow flexibility in target feature labeling determinations and accuracy.

At block 550, the set of labeled features may be updated with the first target feature 550. In various embodiments, systems and methods may receive a manual update to the set of labeled features. The manual update may refine at least one of a location or a specification associated with the first target feature. As such, analysts and operators can confirm, and if necessary, refine, the accuracy of one or more operations discussed herein. The updated set of labeled features may also, optionally, become training data 525 utilized by the feature extraction module.

The processes discussed herein may significantly reduce geospatial image analysis and change updates, compared to traditional manual review. Systems and methods discussed herein may return an updated image label and mapping in minutes, compared to the days it may take a manual reviewer to analyze images, compare features, and label updates. The automated and machine learning techniques discussed herein may significantly improve accuracy, and identify features based on particular feature specifications, object types, and previously labeled sets.

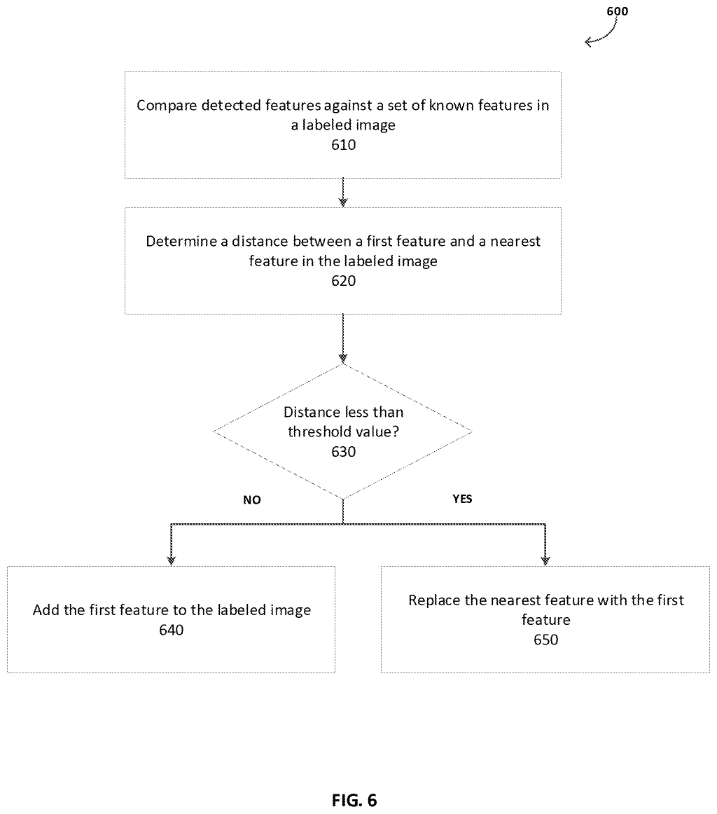

FIG. 6 illustrates a flowchart for updating labeled image 600, according to embodiments. At block 610, systems and methods may compare detected features against a set of known features in a labeled image. The comparison may utilize any of a plurality of methods discussed herein, including but not limited to using one or more trained machine learning modules to extract and identify target features from images. The trained machine learning modules may further associate an object type with each target feature.

At block 620, systems and methods may determine a distance between a first feature an a nearest feature in the labeled image. The distance between the features may be based, for example, on a center point, a closest point between the features, a point defined by the feature specification for the object type, or a manually defined point on one or both features.

At block 630, a threshold distance value determination occurs. The threshold distance value, as discussed herein, may be based on one or more of a feature specification, an object type, and an aggressiveness parameter, e.g., indicative of a variability allowance. The threshold value determination may determine whether the distance between the objects are less than, equal to, or greater than the threshold distance value. Although block 630 determines whether the distance is less than the threshold value, it should be appreciated that the determination may be any comparison between the first feature and the nearest features (e.g., less than, equal to, greater than).

At block 640, when it is determined that the distance is not less than the threshold value, the first feature may be added to the labeled image. The determination may indicate that the first feature is a new feature. In examples, the first feature may also be added to the set of labeled features associated with the geospatial image or an area associated with the geospatial image.

At block 650, when it is determined that the distance is less than the threshold value, the nearest feature may be replaced with the first feature. The determination may indicate, for example, that the first feature is an existing feature. It may be the same as the nearest feature or an update of the nearest feature. In other examples, the first feature may also be added to the set of labeled features.

The results of the determination may also be displayed on a visual mapping of the geospatial area to reflect the newly added or replaced first feature relative to one or more previous feature labels.

While the system and method have been described in terms of what are presently considered to be specific embodiments, the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed:

1. A computer-implemented method comprising:
receiving information indicative of a geospatial image;
applying a trained feature extraction module to detect a first target feature based on a feature specification;
mapping the first target feature against a set of labeled features within an area defined by the geospatial image;
determining that the first target feature is new, based on a threshold distance value between the first target feature and a first labeled feature; and
updating the set of labeled features with the first target feature.

2. The method of claim 1, wherein the feature specification defines an object type based on at least one of an object shape, an object area, or an object size.

3. The method of claim 1, wherein the threshold distance value is based on the feature specification and an aggressiveness parameter, wherein the aggressiveness parameter defines a variability allowance for the feature specification.

4. The method of claim 1, wherein the first target feature is indicative of at least one of a building, a structure, a road, or a land feature.

5. The method of claim 1, wherein the trained feature extraction module performs object recognition trained on at least one set of labeled features.

6. The method of claim 1, further comprising:
detecting, by the trained feature extraction module, a second target feature; and
merging the first and second target features based on a distance parameter and the feature specification.

7. The method of claim 1, wherein the mapping comprises providing a visual mapping of the first target feature relative to the set of labeled features.

8. The method of claim 1, wherein the threshold distance value is based on a center point distance between the first target feature and the first labeled feature.

9. A system comprising:
one or more processors; and
a memory comprising instructions that, when executed by the one or more processors, cause the system to:
receive information indicative of a geospatial image;
apply a trained feature extraction module to detect a set of detected features;
associate an object type with a first feature in the set of detected features;
map the set of detected features against a set of known features in a labeled image;
determine a distance between the first feature and a nearest feature in the labeled image;
generate a threshold distance value based on the object type and an aggressiveness parameter;
add the first feature to the labeled image when the distance is greater than or equal to the threshold distance value; and
replace the nearest feature with the first feature when the distance is less than the threshold distance value.

10. The system of claim 9, wherein the trained feature extraction module detects features based on a feature specification associating the object type with one or more of a shape, an area, or a location.

11. The system of claim 9, wherein the object type is at least one of a building type, a structure, or a landmark.

12. The system of claim 9, wherein the instructions are further configured to cause the system to generate a labeled image displaying the nearest feature in a first color, and the first feature in a second color.

13. The system of claim 9, wherein the instructions are further configured to cause the system to convert the set of known features into a first format comprising at least one of a GeoTIFF file or a shapefile.

14. The system of claim 9, wherein the instructions are further configured to cause the system to update the trained feature extraction module with the first feature.

15. The system of claim 9, wherein the trained feature extraction module is a machine learning model trained on sets of geospatial images comprising labeled features.

16. The system of claim 9, wherein the aggressiveness parameter defines a variability allowance for a feature specification.

17. A computer program product comprising:
a computer-readable storage medium; and
instructions stored on the computer-readable storage medium that, when executed by a processor, causes the processor to:
receive information indicative of a geospatial image;
apply a trained feature extraction module to detect a first target feature;
cause a display to map the first target feature against a set of labeled features within an area defined by the geospatial image;
determine that the first target feature is new, based on a threshold distance value between the first target feature and a first labeled feature, wherein the threshold distance value is based on a feature specification and a variability allowance for the feature specification; and
update the set of labeled features with the first target feature.

18. The computer program product of claim 17, wherein the instructions further include receiving a manual update to the set of labeled features, the manual update refining at least one of a location or a specification associated with the first target feature.

19. The computer program product of claim 17, wherein the trained feature extraction module performs object recognition trained on at least one set of labeled features.

20. The computer program product of claim 17, wherein the instructions further include labeling the first target feature as an existing feature when a distance between the first target feature and the first labeled feature is below the threshold distance value; and labeling the first target feature as a new feature when the distance between the first target feature and the first labeled feature is greater than or equal to the threshold distance value.
